(19) United States
(12) Patent Application Publication
(10) Pub. No.: US 2020/0359854 A1
(43) Pub. Date: Nov. 19, 2020

(54) CLEANING SYSTEMS

(71) Applicant: Brendon Dallas Leon Basinger, Heber City, UT (US)

(72) Inventor: Brendon Dallas Leon Basinger, Heber City, UT (US)

(21) Appl. No.: 16/868,990

(22) Filed: May 7, 2020

Related U.S. Application Data
(60) Provisional application No. 62/849,067, filed on May 16, 2019.

(51) Int. Cl. A47K 10/48; F26B 21/00; A45D 20/16

(52) U.S. Cl. CPC A47K 10/48; A45D 20/16; F26B 21/004

(57) ABSTRACT

A cleaning system for a hand sanitization device may include a cavity defined in a housing sized to receive at least one appendage of a user, at least one pulley system, at least one cleaning belt rotatably coupled to the pulley system, the cleaning belt including a number of protrusions extending from the cleaning belt to clean the appendage of the user, and at least one sterilization device to sanitize the protrusions and the cleaning belt.

### RELATED APPLICATIONS

This application claims the benefit of U.S. Provisional Application Ser. No. 62/849,067, filed May 16, 2019, entitled “Cleaning Systems,” assigned to the assignee hereof and the entirety of which is incorporated herein by reference.

### BACKGROUND

A lack of sanitization within public and private areas has become an issue in several parts of the world and especially where large groups of people congregate and where peoples from around the world come into contact with one another and are able to spread pathogens including a large amount and variety of bacteria and viruses. For example, in areas such as public restrooms, hospitals, restaurants, and other areas, pathogens may be spread from one individual to another readily even when using handsfree sinks and towel dispensers.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a is a perspective view of a hand sanitization device, according to a number of examples of the principles described herein.

FIG. 2 is a is a side cut-away view of the hand sanitization device depicting a cleaning system, according to a number of examples of the principles described herein.

FIG. 3 is a is a side cut-away view of the hand sanitization device depicting a cleaning system and a drying system, according to a number of examples of the principles described herein.

FIG. 4 is a flowchart showing a method of sanitizing a user's appendage, according to an example of the principles described herein.

FIG. 5 is a flowchart showing a method of sanitizing a user's appendage, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As pathogens are easily transmitted in areas of high traffic, it becomes more important to ensure that a user of sanitization devices is able to be left cleaner than before they use the sanitization device. In some instances of a user utilizing, for example, a hand dryer, the user may be left with relatively more pathogens on their skin than when they began using the hand dryer as described by author Adam Boult in his article entitled, “Dyson Airblades ‘spread germs 1,300 times more than paper towels’ found at https://www.telegraph.co.uk/news/2016/04/13/dyson-airblades-spread-germs-1300-times-more-than-paper-towels. Thus, even when individuals take care to clean appropriately and not spread pathogens, it is difficult to do so.

Examples described herein provide a hand sanitization device. The hand sanitization device may include a cavity defined in a housing sized to receive at least one appendage of a user, at least one cleaning belt rotatable within the cavity, the cleaning belt comprising a number of protrusions extending from the cleaning belt to clean the appendage of the user, and at least one sterilization device to sanitize the protrusions and the cleaning belt. The sterilization device may include a steam cleaner. The steam cleaner may be activated as the cleaning belt is rotated. The sterilization device may also include an irradiation device. The irradiation device may be activated as the cleaning belt is rotated.

The hand sanitization device may include a fan located within the housing to create a fluid flow, a motor coupled to the fan to drive the fan; at least one channel to direct the flow of the fluid, and at least one opening fluidically coupled to the channel and directing the fluid flow transversely across an opening of the cavity. The velocity of the fluid flow through the at least one opening is at least 100 m/s. The pressure of the fluid flow through the at least one opening is at least 15 kPa.

The hand sanitization device may also include at least one guard coupled to the housing and adjacent to the cleaning belt. The guard comprises a number of combs through which the protrusions extending from the cleaning belt pass. The hand sanitization device may include a draining system to drain fluids. The hand sanitization device may include a sanitizing fluid dispenser to dispense sanitizing fluid onto the cleaning belt. The housing of the hand sanitization device may include a condensation chamber to retain moisture in the housing.

Further, the hand sanitization device may include a presence detector to detect the presence of the appendage of the user. The hand sanitization device activates the rotation of the cleaning belt, the sterilization device or combinations thereof upon detect of the appendage by the presence detector.

Examples described herein also provide a cleaning system for a hand sanitization device. The cleaning system may include a cavity defined in a housing sized to receive at least one appendage of a user, at least one pulley system, at least one cleaning belt rotatably coupled to the pulley system, the cleaning belt including a number of protrusions extending from the cleaning belt to clean the appendage of the user, and at least one sterilization device to sanitize the protrusions and the cleaning belt. The sterilization device may include a steam cleaner, an irradiation device, or combinations thereof. The sterilization device may be activated as the cleaning belt is rotated about the pulley system.

The cleaning system may include at least one guard coupled to the housing and adjacent to the cleaning belt. The guard may include a number of combs through which the protrusions extending from the cleaning belt pass. The cleaning system may include a sanitizing fluid dispenser to dispense sanitizing fluid onto the cleaning belt.

Examples described herein also provide a method of sanitizing a user's appendage. The method, in response to a detection of an appendage of a user, may include activating at least one cleaning belt rotatably coupled to a pulley system, the cleaning belt comprising a number of protrusions extending from the cleaning belt to clean the appendage of the user, and activating at least one sterilization device to sanitize the protrusions and the cleaning belt. The method may also include activating a motor coupled to a fan, the activation of the motor causing a fluid flow through at least one channel and through at least one opening fluidically coupled to the channel, the fluid flow being directed transversely across an opening.

The method may also include, with a presence detector, detecting a lack of a presence of an appendage of a user adjacent to the cleaning belt. In response to a lack of detection of an appendage of a user, the method may include deactivating cleaning belt, the sterilization device, or combinations thereof.

Hand sanitization devices may include hand dryers that utilize laminar or stratified airflows, and are described in, for example International Patent Application Publication No. WO 2007/015045 A1, entitled “Drying apparatus,” which is hereby incorporated by reference in its entirety.

As used in the present specification and in the appended claims, the term “pathogen” is meant to be understood broadly as any biological entity that causes disease in a user such as a virus, bacterium, protozoan, prion, viroid, or fungus, among other pathogens.

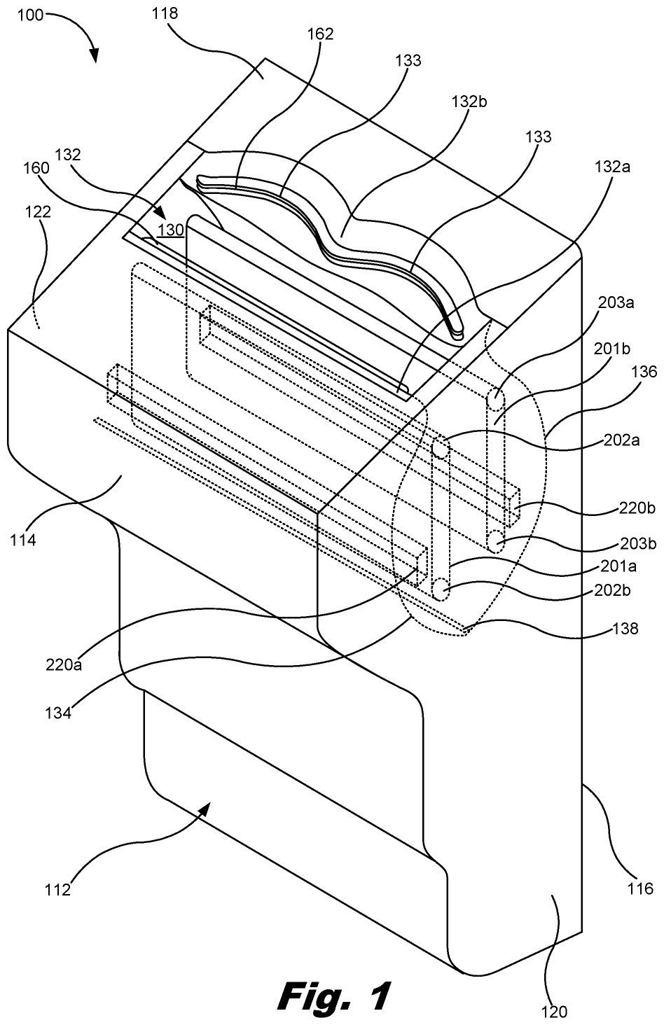

Turning now to the figures, FIG. 1 is a is a perspective view of a hand sanitization device (100), according to a number of examples of the principles described herein. As depicted in FIG. 1, the hand sanitization device (100) may include a housing (112) comprising a front wall (114), a rear wall (116), an upper face (118) and side walls (120, 122). The rear wall (116) can incorporate fixing devices (not shown) for securing the hand sanitization device (100) to a wall or other structure prior to use. An electrical connection (not shown) may also be provided on the rear wall or elsewhere on the housing (112). A cavity (130) is formed in the upper part of the housing (112). The cavity (130) is open at its upper end and delimited thereat by the top of the front wall (114) and the front of the upper face (118). The space between the top of the front wall (114) and the front of the upper face (118) forms a cavity entrance (132) which is sufficiently wide to allow a user's hands to be introduced to the cavity (130) through the cavity entrance (132). The cavity (130) is closed on the sides of the hand sanitization device (100) in order to contain fluids that may be deflected by various moving parts or by air currents during the use of the hand sanitization device (100).

The cavity (130) has a front wall (134) and a rear wall (136) which delimit the cavity (130) to the front and rear respectively. A drain (138) may be included in the lowermost end of the cavity (130) which communicates with a plumbing system that exits from the hand sanitization device (100) or a reservoir (not shown) located in the lower part of the housing (112). The purpose of the drain and reservoir will be described in more detail below.

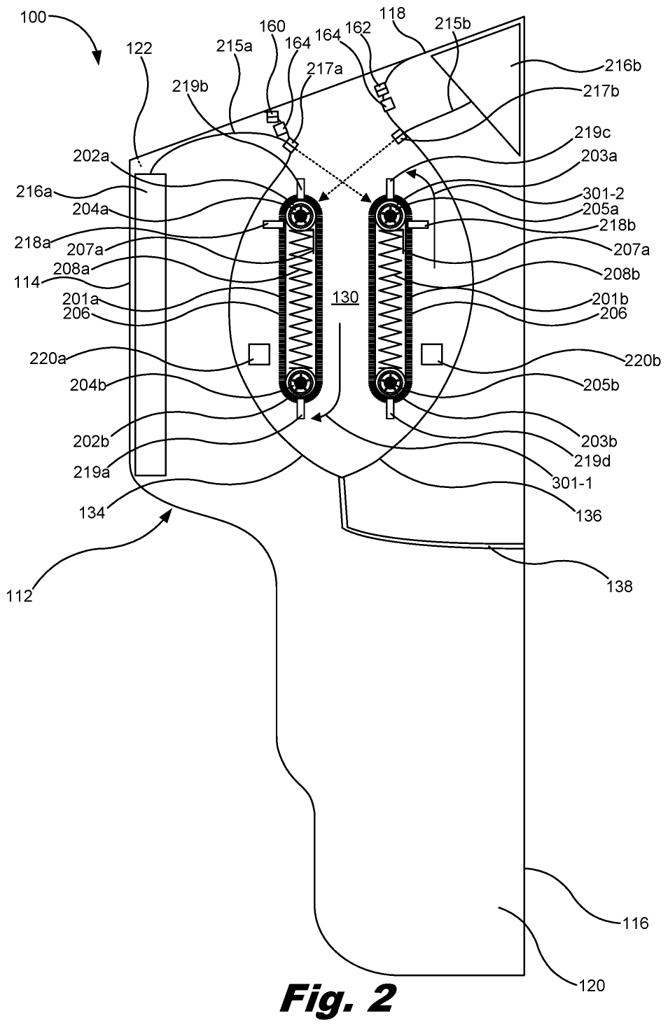

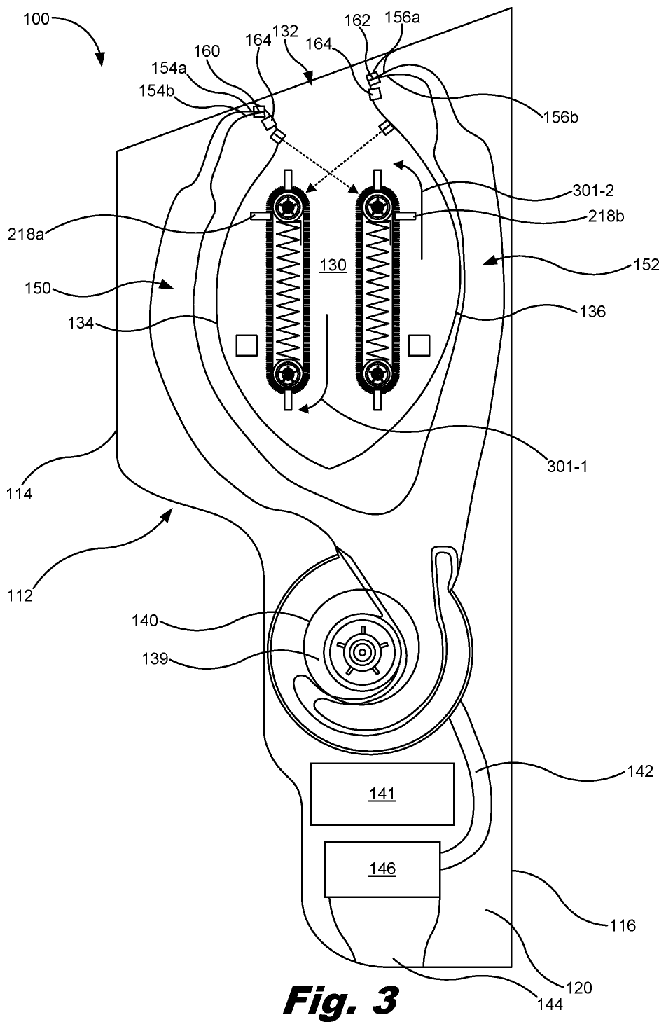

FIG. 2 is a is a side cut-away view of the hand sanitization device (100) depicting a cleaning system, according to a number of examples of the principles described herein. FIG. 3 is a is a side cut-away view of the hand sanitization device (100) depicting a cleaning system and a drying system, according to a number of examples of the principles described herein. As depicted in FIG. 3, a motor (139) is located inside the housing (112). A fan (140), which is driven by the motor (139), is also located inside the housing (112). In one example, the motor (139) may include a brushless switched-reluctance motor. The motor (139) may be electrically coupled to and controlled by a controller (141). The inlet (142) of the fan (140) communicates with an air inlet (144) formed in the housing (112). A filter (146) may be located in the air passageway connecting the air inlet (144) to the fan inlet (142) so as to prevent the ingress of any debris which might cause damage to the motor (139) or the fan (140) and/or contaminate the washing and drying of the user's hands. The outlet of the fan (140) communicates with a pair of air ducts (150, 152) which are located inside the housing (112). The front air duct (150) is located between the front wall (114) of the housing (112) and the front wall (134) of the cavity (130), and the rear air duct (152) is located between the rear wall (116) of the housing (112) and the rear wall (136) of the cavity (130).

The air ducts (150, 152) are arranged to conduct air from the fan (140) to a pair of opposed slot-like openings (160, 162) which are located in the front and rear walls (134, 136) respectively of the cavity (130). The slot-like openings (160, 162) are arranged at the upper end of the cavity (130) in the vicinity of the cavity entrance (132). The slot-like openings (160, 162) are each configured so as to direct an airflow generally across the cavity entrance (132) towards the opposite wall of the cavity (130). The slot-like openings (160, 162) are offset in the vertical direction and angled towards the lowermost end of the cavity (130) in order to ensure that the fluids removed from the user's hands by the air flowing from the slot-like openings (160, 162) is moved toward the bottom of the cavity (130) and into the drain.

The slot-like openings (160, 162) may include widths that allow the airflow within the air ducts (150, 152) to form a laminar airflow. A laminar airflow in fluid dynamics may occur when a fluid flows in parallel layers, with no disruption between the layers. At low velocities, the fluid (i.e., air from the air ducts (150, 152)) tends to flow without lateral mixing, and adjacent layers slide past one another like playing cards. There are no cross-currents perpendicular to the direction of flow, nor eddies or swirls of fluids. In laminar flow, the motion of the particles of the fluid is very orderly with particles close to a solid surface moving in straight lines parallel to that surface. Laminar flow is a flow regime characterized by high momentum diffusion and low momentum convection. When a fluid is flowing through a closed channel such as the channel formed by the slot-like openings (160, 162), either of two types of flow may occur depending on the velocity and viscosity of the fluid: laminar flow or turbulent flow. Laminar flow tends to occur at lower velocities, below a threshold at which it becomes turbulent. Turbulent flow is a less orderly flow regime that is characterized by eddies or small packets of fluid particles, which result in lateral mixing. In non-scientific terms, laminar flow is smooth, while turbulent flow is rough. The laminar flow of air from the slot-like openings (160, 162) acts as a squeegee to remove water from the hands of the user. The width of the slot-like openings (160, 162) may be identical or different from one another. In one example, the width of the slot-like opening (160) may be approximately 0.3 millimeters (mm) and the width of the slot-like opening (162) may be approximately 0.4 mm.

In one example, the laminar flow produced by the slot-like openings (160, 162) and activation of the motor (139) and fan (140) may include velocities of at least 100 meters per second (m/s). In one example, the laminar flow produced by the slot-like openings (160, 162) and activation of the motor (139) and fan (140) may include pressures of at least 15 kilopascals (kPa).

Sensors (164) may be included and positioned in the front and rear walls (134, 136) of the cavity (130) adjacent to the slot-like openings (160, 162). These sensors (164) detect the presence of a user's hands which are inserted into the cavity (130) via the cavity entrance (132) and are arranged to send an activation signal to the motor (139) when a user's hands are introduced to the cavity (130). As depicted in FIG. 3, the walls of the ducts (150, 152) project slightly beyond the surface of the front and rear walls (134, 136) of the cavity (130). The inward projection of the walls (154a, 154b, 156a, 156b) of the ducts (150, 152) reduces the tendency of the user's hands to be sucked towards one or other of the walls (134, 136) of the cavity (130), which enhances the ease with which the hand sanitization device (100) can be used. The positioning of the sensors (164) juxtaposition to the inwardly projecting walls (154a, 154b, 156a, 156b) of the ducts (150, 152) also reduces the risk of the sensors (164) becoming dirty and inoperative. In one example, the sensors (164) may wired or wirelessly communicate with the controller (141), allowing the information sensed by the sensors (164) to be used by the controller (141) to activate the various elements of the hand sanitization device (100).

As depicted in FIG. 1, the shape of the cavity entrance (132) includes a front edge (132a) that is generally straight and extends laterally across the width of the hand sanitization device (100). In contrast, the rear edge (132b) includes a shape that includes two curved portions (133) which follow the shape of the backs of a pair of human hands as they are inserted downwardly into the cavity (130) through the cavity entrance (132). The rear edge (132b) of the cavity entrance (132) is substantially symmetrical about the center line of the hand sanitization device (100). The intention of the shaping and dimensioning of the front and rear edges (132a, 132b) of the cavity entrance (132) is such that, when a user's hands are inserted into the cavity (130) through the cavity entrance (132), the distance from any point on the users hands to the nearest slot-like openings (160, 162) is substantially uniform.

The hand sanitization device (100) described above operates in the following manner. When a user's hands are first inserted into the cavity (130) through the cavity entrance (132), the sensors (164) detect the presence of the user's hands and send a signal to the motor (139) to drive the fan (140). The motor (139) has a rotor which is then driven at a very high speed. In one example, the motor (139) may be driven at a speed of at least 80,000 rpm. In another example, the motor (139) may be driven at a speed of at least 100,000 rpm. In this manner, the fan (140) is rotated very high speed. Ambient air is drawn into the hand sanitization device (100) via the air inlet (144) at a rate of, for example, approximately 20 to 40 liters per second, at a rate of least 25 to 27 liters per second, or at a rate of 31 to 35 liters per second. The air passes through the filter (146) and along the fan inlet (142) to the fan (140). The airflow leaving the fan (140) is divided into two separate airflows with one passing along the front air duct (150) to the slot-like opening (160) and the other passing along the rear air duct (152) to the slot-like opening (162).

The airflow is ejected from the slot-like openings (160, 162) in the form of very thin, stratified sheets of high velocity, high pressure air. As the airflows leave the slot-like openings (160, 162), in one example, the air pressure may be at least 15 kilopascals (kPa), and, in another example, the air pressure may be approximately 20 to 23 kPa. Furthermore, the speed of the airflow leaving the slot-like openings (160, 162) may be at least 80 meters per second (m/s), in another example, at least 100 or 150 m/s, and in yet another example, approximately 180 m/s. Because the size of the slot-like opening (162) located at the end of the rear duct (152) is greater than the size of the slot-like opening (160) located at the end of the front duct (150), a larger volume of air is emitted from the duct (152) than from the duct (150). This provides a greater mass of air for drying the backs of the user's hands.

The two thin sheets of stratified, laminar, high velocity, high pressure air are directed towards the surfaces of the user's hands which, during use, are inserted fully into the cavity (130) and are subsequently withdrawn from the cavity (130) via the cavity entrance (132). As the user's hands pass into and out of the cavity (130), the laminar flow or sheets of air blow any existing water off the user's hands. This is achieved reliably and effectively because of the high momentum of the air leaving the slot-like openings (160, 162) and because the airflow is evenly distributed along the length of each slot-like opening (160, 162).

Each stratified sheet of air is directed towards the wall of the cavity (130) which is remote from the slot-like opening through which the respective sheet of air is emitted. Because the slot-like openings (160, 162) are also inclined towards the lowermost end of the cavity (130), the emitted airflows are directed into the cavity (130). This reduces the risk of turbulent air movement being felt by the user outside the housing such as, for example, in the user's face.

In one example, a small number of passes of the user's hands past the slot-like openings (160, 162) of the sanitization device (100) described herein may be used to dry a user's hands to a satisfactory degree. A “pass” may refer to a single insertion of the hands into the cavity and subsequent removal therefrom at a speed which is not unacceptable to an average user. In one example, a single pass may have a duration of approximately 3 seconds. The momentum achieved by the airflows is sufficient to remove the majority of water found on the surface of the user's hands after washing during a single pass. The water removed by the airflows is collected inside the cavity (130). Each airflow will rapidly lose its momentum once it has passed the user's hands and the water droplets will fall to the lower end of the cavity (130) under the forces of gravity whilst the air exits the cavity (130). The water may be collected by the drain (138) and passed to a reservoir (not shown) where it is collected for disposal or to a drain system that is part of the plumbing system (not shown) of the building to which the hand sanitization device (100) is installed.

In one example, the slot-like openings (160, 162) may not be of constant width across the length of the cavity of the hand sanitization device (100). In this example, the curved portions (133) of the rear edge (132b) are symmetrical about the center line of the cavity entrance (132) with the center portion of the rear edge (132b) being closer to the front edge (132a) at the center line than at a position spaced from the center line. The minimum distance between the front and rear edges (132a, 132b) is at the center line. The distance between the front edge (132a) and the rear edge (132b) is at a maximum at a mid-point of each curved portion (133). The width of the slot-like opening (162) in the rear wall (116) may vary gradually, increasing towards the mid-point of the opening, at the center line of the cavity entrance (132).

Referring to FIGS. 1, 2, and 3, the hand sanitization device (100) may include a cleaning system to clean the user's hands as the user inserts their hands into the cavity (130). Throughout FIGS. 1, 2 and 3, elements included in one drawing of the hand sanitization device (100) are included within the other drawings of the hand sanitization device (100) but may not be portrayed in all drawings for clarity purposes. Thus, reference is made to all of FIGS. 1 through 3 together as if all the elements collectively included with FIGS. 1 through 3 are included in a single example of the hand sanitization device (100).

The cleaning system may include at least one belt (201), and, in the examples described herein, include two belts (201a, 201b, collectively referred to as 201). The belts (201) may each be rotatable about a pair of rollers (202a, 202b, 203a, 203b, collectively referred to as 202 and 203, respectively). The belts (201) rotate about the rollers (202, 203), and the rollers (202, 203) may be driven by at least two roller motors with at least one roller motor (204a, 204b, 205a, 205b, collectively referred to as 204 and 205, respectively) driving each of the belts (201). In one example, four separate roller motors (204, 205) drive each of the rollers (202, 203). The controller (141) may be electorally coupled to the roller motors (204, 205) and may activate the roller motors (204, 205). In one example, the activation of the roller motors (204, 205) may be controlled by the controller (141) based on the sensing of a user's hands via the sensors (164) as the user inserts their hands into the cavity (130) through the cavity entrance (132).

Once activated, the roller motors (204, 205) may rotate in the direction of arrows 301-1 and 301-2. This direction of rotation may allow the fluids in the belts (201) to remain within the cavity (130) and be forced to the bottom of the cavity (130). The belts (201) may include a number of protrusions (206) extending from the surface of the belts (201) that act as cleaning bristles or filaments to clean the user's hands. The protrusions (206) may include any material that may be used to scrub the user's hands as the belts (201) are rotated, and that material may include the following properties: a stiffness including, for example, tensile modulus and tensile strength, a value that defines how well the protrusions return to an original state after being bent referred to herein as a flicking action, a value that defines the protrusions' ability to return to an original position after being bent referred to herein as a bend recovery, an abrasion resistance value that defines the protrusions' ability to resist wear, a flex fatigue resistance value that defines how many times the protrusions can be bent back and forth before becoming damaged, a set resistance value that defines the protrusions' ability to straighten completely after being moderately flexed for a long period of time, chemical resistance, solvent resistance, oxidation resistance, and other physical properties. In one example, the protrusions (206) may be made of a plastic or rubber material.

A lever (207a, 207b, collectively referred to herein as 207) may be mechanically coupled to each pair of rollers (203). A spring (208a, 208b, collectively referred to herein as 208) biased between each pair of rollers (203) may be used to separate each of the pairs of the rollers (203) from one another in order to provide tension between the belt (201) and the rollers (203) such that the friction between the rollers (203) and the belt (201) causes the belt (201) to rotate about the pair of rollers (203) as the roller motors (204, 205) rotate the rollers (203). The rollers (203) and levers (207) together for a pulley system that causes the belt (201) to rotate about the rollers (203).

The lever (207) for each pair of rollers (203) may be mechanically activated to overcome the bias of the springs (208). Overcoming the bias of the springs (208) via the levers (207) causes the tension between the rollers (203) to be reduced and allows the belts (201) coupled to the pairs of rollers (203) to be removed and replaced if the belts (201) and/or their protrusions (206) become damaged or worn. In the examples described herein, a pair of the rollers (203) may be coupled to the housing (112) or other support within the hand sanitization device (100) in such a manner that the rollers (203) are able to move relative to one another's position. In one example, a hinge may be coupled to one of the rollers (203) within each pair of rollers (203) to allow for this movement to occur when the lever (207) is used to overcome the bias created by the spring (208). In this manner, the belt (201) may be serviced.

A number of cleaning screens (219a, 219b, 219c, 219d, collectively referred to herein as 219). The cleaning screens (219) act as guards and may include comb-like elements that include protrusions extending from a common substrate. The cleaning screens (219) may be coupled to, for example, the side walls (120, 122) of the housing (112) and placed adjacent to the belts (201) such that the protrusions (206) extending from the surface of the belts (201) may move between a number of protrusions formed in the of the cleaning screens (219). As the protrusions (206) extending from the surface of the belts (201) move between a number of protrusions formed in the of the cleaning screens (219), larger debris that may be on the user's hands are removed from the protrusions (206) extending from the surface of the belts (201) and the protrusions (206) extending from the surface of the belts (201) are cleaned.

The hand sanitization device (100) may include a number of belt sterilization devices to assist in ensuring that the belts (201) are sanitary throughout operation. In one example, the hand sanitization device (100) may include a steam cleaner (220a, 220b, collectively referred to herein as 220) adjacent to each of the belts (201). The steam emitted by the steam cleaners (220) comes into contact with the protrusions (206) extending from the surface of the belts (201), and, due to the steam emitted by the steam cleaners (220), the protrusions are quickly cleaned and sanitized. Steam is effective enough of a cleaning method as to disinfect and sterilize the surfaces of the protrusions (206). In one example, the steam may be produced in a boiler that forms part of the build infrastructure to which the hand sanitization device (100) is coupled. In this example, the boiler may heat water to high temperatures between, for example, 240° F. and 310° F. (115° C. and 155° C.) to produce low-pressure, low moisture (e.g. approximately 4% to 6% water) water vapor in the form of steam. Further, the steam cleaners (220) provide energy to break soil bonds and release contaminants into water suspension, after which the soil and contaminants may be removed by the cleaning screens (219) wiping the soil and contaminants away from the protrusions (206) and down the drain (138).

In another example, the belt sterilization devices may include, instead of or in addition to the steam cleaner (220), an irradiation device (218a, 218b, collectively referred to herein as 218). The irradiation devices (218) may be placed at any position next to the belts (201), and the electromagnetic radiation emitted by the irradiation devices (218) may be directed to the protrusions (206) extending from the belts (201). The irradiation devices (218) may emit ionizing radiation to sterilize the protrusions (206). The ionizing radiation may include, for example, electron beams, X-rays and gamma rays, and may be used to kill pathogens that may be transferred from the user's hands to the protrusions (206) as the user cleans their hands.

In another example, the belt sterilization devices may include, instead of or in addition to the steam cleaner (220) and/or the irradiation device (218), sterilizing fluid dispensers (217a, 217b, collectively referred to herein as 217). The sterilizing fluid dispensers (217) may dispense a sterilizing fluid from a number of sterilizing fluid reservoirs (216a, 216b, collectively referred to herein as 216) via a number of ducts (215a, 215b, collectively referred to herein as 215). In one example, the sterilizing fluid dispensers (217) may include motors or actuators to move the sterilizing fluid from the reservoirs (216), through the ducts (215) and out through the sterilizing fluid dispensers (217). The sterilizing fluid may include, for example, a sterile fluid, a cleaning fluid such as an antibacterial soap that includes triclocarban, benzalkonium chloride, benzethonium chloride, and chloroxylenol, or combinations thereof, an antiseptic fluid, an antibacterial fluid, a disinfectant fluid, a germicide fluid, a viricide fluid, an antifungal fluid, hydrogen peroxide, iodine, an alcohol such as ethanol and isopropanol, or combinations thereof. In this manner, the sterilizing fluid dispensed by the sterilizing fluid dispensers (217) may clean and sterilize the user's hands. In one example, the sterilizing fluid dispensers (217) may dispense the sterilizing fluid onto or toward the protrusions (206) of the belts (201) as indicated by the dotted arrows directed from the sterilizing fluid dispensers (217) so that when the user inserts their hands, the fluid may be dispensed both onto the user's hands and onto the protrusions to scrub the user's hands. The reservoirs (216) may be replenished with sterilizing fluid much like soaps or other products are replenished during regular maintenance processes. In one example, the sterilizing fluid within the reservoirs (216) may be replenished by introducing additional sterilizing fluid into the reservoirs (216) through an opening within the reservoirs (216). In another example, the reservoirs (216) may be removed from the hand sanitization device (100) once the sterilizing fluid is depleted and replaced with a reservoir (216) that contains sterilizing fluid.

The sterilization devices including the steam cleaners (220), irradiation devices (218), sterilizing fluid dispensers (217), and combinations thereof may be activated by the controller (141) based on detection of the user's hands by the sensors (164). In one example, the sterilization devices (220, 218, 217) may activate quick enough to ensure that their sanitizing functions as to the belts (201) and the protrusions (206) are completed before the user's hands reach the belts. Further, in one example, the sterilization devices (220, 218, 217) may continue to operate after the user's hands have been removed (i.e., no longer detected by the sensors (164)) so that the belts (201) and the protrusions (206) are completely sanitized and sterilized by the sterilization devices (220, 218, 217) for a next user.

The rotation of the belts (201) in the direction of arrows 301-1 and 301-2 causes the pathogens, debris, and other materials the hand sanitization device (100) seeks to remove from the user's hands to be moved to the bottom of the cavity (130) and as greywater waste down the drain (138). In this manner, the waste from the user's hand is safely removed from the hand sanitization device (100).

The activation of the various elements of the hand sanitization device (100) using the controller (141) including, for example, the motor (139) to move the fan (140), the sterilizing fluid dispensers (217), the roller motors (204) to rotate the rollers (202, 203) and the belts (201), the steam cleaners (220), the irradiation devices (218), the sterilizing fluid dispensers (217), other elements of the hand sanitization device (100) and combinations thereof, may be performed at any time during the operation of the hand sanitization device (100). In one example, the controller (141) may activate the motor (139), the sterilizing fluid dispensers (217), the roller motors (204), the steam cleaners (220), the irradiation devices (218), the sterilizing fluid dispensers (217), other elements of the hand sanitization device (100) and combinations thereof, as the sensors (164) detect the user's hands move past the sensors (164), after the user's hands pass the sensors (164), during the detection of the user's hands within the cavity (130), after the sensors (164) detect the user's hands leave the cavity (130) or otherwise cease to detect the user's hands, and combinations thereof. Further, in another example, the controller (141) of the hand sanitization device (100) may use the controller (141) to activate the motor (139), the sterilizing fluid dispensers (217), the roller motors (204), the steam cleaners (220), the irradiation devices (218), the sterilizing fluid dispensers (217), other elements of the hand sanitization device (100) and combinations thereof, at any time the sensors (164) do not detect the user's hands. In this example, the hand sanitization device (100) may perform a cleaning operation to clean the belts (201) and protrusions (206) when the hand sanitization device (100) is not in use in order to ensure that the belts (201) and protrusions (206) are appropriately sanitized and sterilized.

In one example, the sterilization devices including the steam cleaners (220), irradiation devices (218), sterilizing fluid dispensers (217), and combinations thereof may be activated by the controller (141) as the controller (141) activates the belts (201). In another example, the sterilization devices including the steam cleaners (220), irradiation devices (218), sterilizing fluid dispensers (217), and combinations thereof may be activated by the controller (141) before the controller (141) activates the belts (201). In another example, the sterilization devices including the steam cleaners (220), irradiation devices (218), sterilizing fluid dispensers (217), and combinations thereof may be activated by the controller (141) after the controller (141) activates the belts (201). In still another example, the sterilization devices including the steam cleaners (220), irradiation devices (218), sterilizing fluid dispensers (217), and combinations thereof may be activated by the controller (141) independent of the controller (141) activating the belts (201).

The space between the belts (201) and the front wall (134) and the rear wall (136) of the housing (112) that form the cavity (130) acts as a condensation chamber where the steam produced by the steam cleaners (220) may condense and flow to the drain (138). In this manner, the fluids and debris within the cavity (130) may safely be disposed of without the user being brought into contact with any of the fluids or debris. Further, the condensation chambers reduce the likelihood that the fluids and debris are retained within the housing (112) and are not ejected through the cavity entrance (132) of the cavity (130).

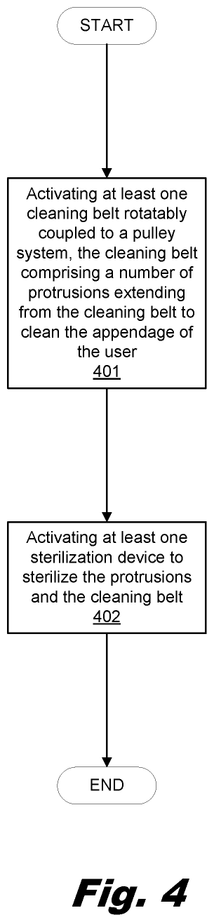

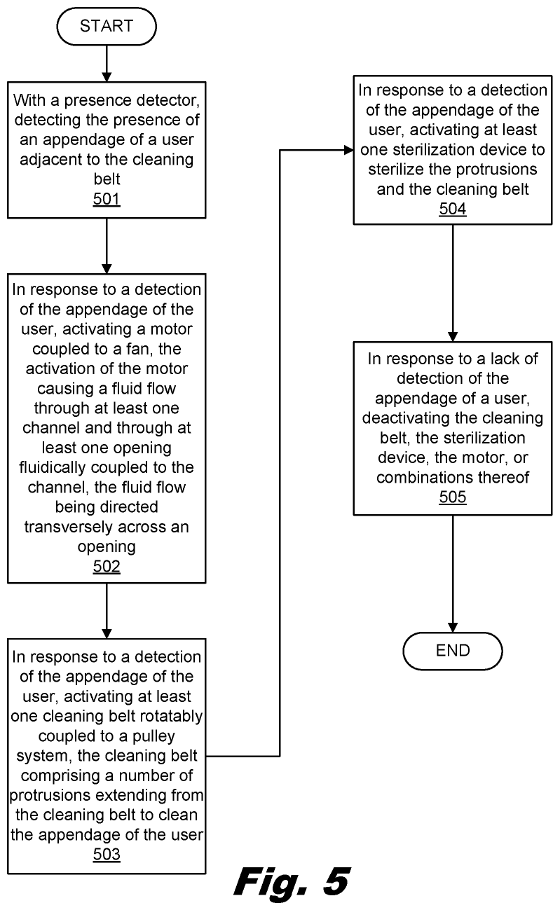

Having described the hand sanitization device (100), reference is now made to the methods of operation of the hand sanitization device (100) described in connection with FIGS. 4 and 5. FIG. 4 is a flowchart (400) showing a method of sanitizing a user's appendage, according to an example of the principles described herein. The method (400) of FIG. 4 may include activating (block 401) at least one cleaning belt (201) rotatably coupled to the rollers (203) and the pulley system formed by the levers (207) and springs (208). The belts (201) include the protrusions (206) that extend from the belt (201) to clean the appendage of the user.

The method (400) may also include activating (block 402) at least one sterilization device (220, 218, 217) including the steam cleaners (220), irradiation devices (218), sterilizing fluid dispensers (217), and combinations thereof to sanitize and sterilize the protrusions (206) and the belts (201). The sterilization device (220, 218, 217) sterilizes the protrusions (206) and the belts (201) such that subsequent users of the hand sanitization device (100) may use a device from which pathogens have been removed.

FIG. 5 is a flowchart showing a method (500) of sanitizing a user's appendage, according to an example of the principles described herein. The method of FIG. 5 may include, with a presence detector such as the sensors (164), detecting (block 501) the presence of an appendage of a user adjacent to at least one of the cleaning belts (201). The method (500) of FIG. 5 may also include, in response to a detection of an appendage of a user and with the controller (141), activating (block 502) a motor (139) coupled to a fan (140). The activation (block 502) of the motor (139) causes a fluid flow through at least one channel such as the air ducts (150, 152) which are located inside the housing (112), and through at least one opening such as the pair of opposed slot-like openings (160, 162) fluidically coupled to the channel (150, 152). The fluid flow is directed transversely across the cavity entrance (132) of the cavity (130).

Further, in response to a detection of an appendage of a user, the controller (141) may activate (block 503) at least one cleaning belt (201) rotatably coupled to a pulley system formed by the levers (207) and springs (208). The belt (201) includes a number of protrusions (206) extending from the belt (201) to clean the appendage of the user.

Further, in response to a detection of an appendage of a user, the controller (141) may activate (block 504) at least one sterilization device (220, 218, 217) including the steam cleaners (220), irradiation devices (218), sterilizing fluid dispensers (217), and combinations thereof to sanitize the protrusions (206) and the belt (201). In this manner, the belt (201) and protrusions (206) are continually sanitized and sterilized both during operation and between instances of operation of the hand sanitization device (100).

The method (500) may also include, with the presence detector (164), detecting the lack of a presence of an appendage of a user adjacent to the cleaning belts (201), and, in response to a lack of detection of an appendage of a user by the presence detector (164) and with the controller (141), deactivating (block 505) the cleaning belt (201), at least one of the sterilization devices (220, 218, 217), the motor (139), or combinations thereof. In this manner, the various elements of the hand sanitization device (100) may be deactivated after use by a user.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (XXX) of the computer (XXX) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a cleaning system for a hand sanitization device. The cleaning system may include a cavity defined in a housing sized to receive at least one appendage of a user, at least one pulley system, at least one cleaning belt rotatably coupled to the pulley system, the cleaning belt including a number of protrusions extending from the cleaning belt to clean the appendage of the user, and at least one sterilization device to sanitize the protrusions and the cleaning belt. The cleaning system along with the hand sanitization device in which the cleaning system operates serve to ensure that a user may properly wash their hands while also ensuring that pathogens are removed from the user's hands and not transmitted to subsequent users.

The preceding description has been presented to illustrate and describe examples of the principles described. This description is not intended to be exhaustive or to limit these principles to any precise form disclosed. Many modifications and variations are possible in light of the above teaching.

What is claimed is:

1. A hand sanitization device, comprising:
a cavity defined in a housing sized to receive at least one appendage of a user;
at least one cleaning belt rotatable within the cavity, the cleaning belt comprising a number of protrusions extending from the cleaning belt to clean the appendage of the user; and
at least one sterilization device to sterilize the protrusions and the cleaning belt.

2. The hand sanitization device of claim 1, wherein the sterilization device comprises a steam cleaner, the steam cleaner being activated as the cleaning belt is rotated.

3. The hand sanitization device of claim 1, wherein the sterilization device comprises an irradiation device, the irradiation device being activated as the cleaning belt is rotated.

4. The hand sanitization device of claim 1, comprising:
a fan located within the housing to create a fluid flow;
a motor coupled to the fan to drive the fan;
at least one channel to direct the flow of the fluid; and
at least one opening fluidically coupled to the channel and directing the fluid flow transversely across an opening of the cavity.

5. The hand sanitization device of claim 4, wherein the velocity of the fluid flow through the at least one opening is at least 100 m/s.

6. The hand sanitization device of claim 4, wherein the pressure of the fluid flow through the at least one opening is at least 15 kPa.

7. The hand sanitization device of claim 1, comprising:
at least one guard coupled to the housing and adjacent to the cleaning belt.

8. The hand sanitization device of claim 7, wherein the guard comprises a number of combs through which the protrusions extending from the cleaning belt pass.

9. The hand sanitization device of claim 1, comprising a draining system to drain fluids.

10. The hand sanitization device of claim 1, comprising a sterilizing fluid dispenser to dispense sanitizing fluid onto the cleaning belt.

11. The hand sanitization device of claim 1, wherein the housing comprises a condensation chamber to retain moisture in the housing.

12. The hand sanitization device of claim 1, comprising a presence detector to detect the presence of the appendage of the user, wherein the hand sanitization device activates the rotation of the cleaning belt, the sterilization device or combinations thereof upon detect of the appendage by the presence detector.

13. A cleaning system for a hand sanitization device, comprising:
a cavity defined in a housing sized to receive at least one appendage of a user;
at least one pulley system;
at least one cleaning belt rotatably coupled to the pulley system, the cleaning belt comprising a number of protrusions extending from the cleaning belt to clean the appendage of the user; and
at least one sterilization device to sterilize the protrusions and the cleaning belt.

14. The cleaning system of claim 13, wherein the sterilization device comprises a steam cleaner, an irradiation device, or combinations thereof, the sterilization device being activated as the cleaning belt is rotated about the pulley system.

15. The cleaning system of claim 13, comprising at least one guard coupled to the housing and adjacent to the cleaning belt, the guard comprising a number of combs through which the protrusions extending from the cleaning belt pass.

16. The cleaning system of claim 13, comprising a sterilizing fluid dispenser to dispense sanitizing fluid onto the cleaning belt.

17. A method of sanitizing a user's appendage, comprising, in response to a detection of an appendage of a user:
activating at least one cleaning belt rotatably coupled to a pulley system, the cleaning belt comprising a number of protrusions extending from the cleaning belt to clean the appendage of the user; and
activating at least one sterilization device to sanitize the protrusions and the cleaning belt.

18. The method of claim 17, comprising activating a motor coupled to a fan, the activation of the motor causing a fluid flow through at least one channel and through at least one opening fluidically coupled to the channel, the fluid flow being directed transversely across an opening.

19. The method of claim 17, comprising, with a presence detector, detecting a lack of a presence of an appendage of a user adjacent to the cleaning belt.

20. The method of claim 17, comprising, in response to a lack of detection of an appendage of a user, deactivating cleaning belt, the sterilization device, or combinations thereof.
